(19) United States
(12) Patent Application Publication
(10) Pub. No.: US 2011/0216076 A1
(43) Pub. Date: Sep. 8, 2011

(54) APPARATUS AND METHOD FOR PROVIDING ANIMATION EFFECT IN PORTABLE TERMINAL

(75) Inventors: Hak-Soo Kim, Suwon-si (KR); Jong-Keun Cho, Ansan-si (KR); Byoung-Ho Yun, Seoul (KR); Chul-Sang Chang, Seoul (KR)

(73) Assignee: SAMSUNG ELECTRONICS CO., LTD., Suwon-si (KR)

(21) Appl. No.: 13/039,103

(22) Filed: Mar. 2, 2011

(30) Foreign Application Priority Data
Mar. 2, 2010 (KR) 10-2010-0018406

(51) Int. Cl. G06T 13/00

(52) U.S. Cl. 345/473

(57) ABSTRACT

An apparatus and method for providing a highly-realistic animation effect in a portable terminal. An apparatus for providing an animation effect in a portable terminal includes an animation processing unit increasing the realism of an animation by performing a composite animation scheme that continuously processes a key frame animation, which is represented in a fixed pattern, and a physical animation that is realistically represented according to peripheral environments. The apparatus also includes a display unit displaying an animation played by the animation processing unit

### CROSS-REFERENCE TO RELATED APPLICATION(S) AND CLAIM OF PRIORITY

This application claims priority under 35 U.S.C. §119 to an application filed in the Korean Intellectual Property Office on Mar. 2, 2010 and assigned Serial No. 10-2010-0018406, the entire disclosure of which is hereby incorporated by reference.

### TECHNICAL FIELD OF THE INVENTION

The present invention relates generally to an apparatus and method for providing a highly realistic animation effect in a portable terminal, and in particular, to an apparatus and method for providing a highly realistic animation effect in a portable terminal by continuously processing a key frame animation, which is represented in a fixed frame, and a physical animation that can be realistically represented according to peripheral environments.

### BACKGROUND OF THE INVENTION

Recently, portable terminals are being widely used as necessary articles of modern persons without distinction of age and sex, and are being used as media capable of wireless voice communication and information exchange.

At the early stage of popularization, portable terminals were merely recognized to be portable and capable of wireless communication. However, with the development of technology, service providers and terminal manufacturers are competitively developing products (or services) for differentiation from other competitors.

For example, portable terminals evolve into multimedia devices to provide various services such as phone books, games, short messages, E-mails, wake-up calls, MP3, schedule managing functions, digital cameras, and wireless Internet services.

Recently, portable terminals are providing a three-dimensional (3D) graphic function for playing a plurality of 3D object images in a 3D space.

The portable terminal with a 3D graphic function represents a dynamic motion of an object by a key frame scheme. However, the key frame scheme represents a motion of an object in a fixed pattern, thus reducing the realism.

FIGS. 1A, 1B, and 1C illustrate a diagram a process for providing an animation effect by a key frame scheme in a portable terminal.

FIG. 1A is a diagram of an early-stage process for representing an animation by a key frame scheme in a portable terminal.

As shown in FIG. 1A, the portable terminal plays a closing animation “THE END” by a key frame animation scheme.

When playing the closing animation, the portable terminal displays a “THE” frame 100 and an “END” frame 102 to represent the two frames by the key frame animation scheme in a fixed pattern (e.g., such that the two frames meet with each other in a predetermined mode).

FIG. 1B illustrates a diagram of a middle-stage process for representing an animation by a key frame scheme in a portable terminal.

As shown in FIG. 1B, in order to play an animation by the key frame animation scheme, the portable terminal plays the two frames 100 and 102 in a fixed pattern.

That is, the portable terminal moves the two frames 100 and 102 in a fixed pattern (104 and 106) such that the two frames 100 and 102 meet with each other.

FIG. 1C illustrates a diagram of the result of representing an animation by a key frame scheme in a portable terminal.

As shown in FIG. 1C, when playing an animation configured to represent a “THE” frame and an “END” frame in a fixed pattern, the portable terminal moves the two patterns in a fixed pattern (108) such that the two frames meet with each other in a predetermined mode.

When the animation is played by the key frame animation scheme, the realism of the animation is reduced due to the fixed pattern movement.

The portable terminal may increase the realism of an animation by a physical animation scheme, which represents an object differently in real time according to the peripheral states and the states of the object, but the real-time dynamic representation may differ according to the peripheral states and the states of the object.

Also, the key frame animation scheme and the physical animation scheme must be independently performed in the portable terminal.

### SUMMARY OF THE INVENTION

To address the above-discussed deficiencies of the prior art, it is a primary aspect of the present invention to substantially solve at least the above problems and/or disadvantages and to provide at least the advantages below. Accordingly, an object of the present invention is to provide an apparatus and method for providing a highly-realistic animation effect in a portable terminal.

Another object of the present invention is to provide an apparatus and method for performing a key frame animation scheme and a physical animation scheme in a mixed manner to provide a highly-realistic animation in a portable terminal.

Yet another object of the present invention is to provide an apparatus and method for extracting physical properties in a key frame animation process and using the extracted physical properties in a physical animation process to provide a highly-realistic animation in a portable terminal.

According to an aspect of the present invention, an apparatus for providing an animation effect in a portable terminal includes: an animation processing unit increasing the realism of an animation by performing a composite animation scheme that continuously processes a key frame animation, which is represented in a fixed pattern, and a physical animation that is realistically represented according to peripheral environments; and a display unit displaying an animation played by the animation processing unit.

According to another aspect of the present invention, a method for providing an animation effect in a portable terminal includes: increasing the realism of an animation by performing a composite animation scheme that continuously processes a key frame animation, which is represented in a fixed pattern, and a physical animation that is realistically represented according to peripheral environments; and displaying an animation played by the animation processing unit.

According to another aspect of the present invention, an animation processing device for providing an animation effect includes: a key frame animation engine performing a key frame animation scheme; a physical animation engine performing a physical animation scheme when a key frame animation portion is ended; and a property information extracting unit extracting physical property information in the key frame animation scheme to be used as an input of the physical animation scheme.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1A illustrates an early-stage process for representing an animation by a key frame scheme in a portable terminal;

FIG. 1B illustrates a middle-stage process for representing an animation by a key frame scheme in a portable terminal;

FIG. 1C illustrates a result of representing an animation by a key frame scheme in a portable terminal;

FIG. 2 illustrates a block diagram of a portable terminal for representing a composite animation according to the present invention;

FIG. 3 illustrates a format of a composite animation used in a portable terminal according to the present invention;

FIG. 4 illustrates a process for representing an animation in a portable terminal according to an embodiment of the present invention;

FIG. 5 illustrates an animation smoothing process for extracting physical properties from a key frame animation in a portable terminal according to an embodiment of the present invention;

FIG. 6A illustrates an early-stage process for representing an animation by a key frame scheme in a portable terminal according to an embodiment of the present invention;

FIG. 6B illustrates a middle-stage process for representing an animation by a key frame scheme in a portable terminal according to an embodiment of the present invention;

FIG. 6C illustrates a process for representing an animation by a physical animation scheme in a portable terminal according to an embodiment of the present invention; and

FIG. 6D illustrates an animation playing screen according to a physical animation scheme in a portable terminal according to an embodiment of the present invention.

Throughout the drawings, like reference numerals will be understood to refer to like parts, components and structures.

### DETAILED DESCRIPTION OF THE INVENTION

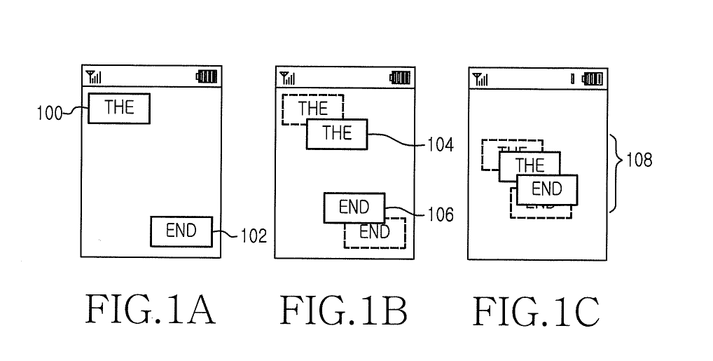

FIGS. 1A through 6D, discussed below, and the various embodiments used to describe the principles of the present disclosure in this patent document are by way of illustration only and should not be construed in any way to limit the scope of the disclosure.

The present invention provides an apparatus and method for performing a key frame animation scheme and a physical animation scheme in a mixed manner to provide a highly-realistic animation in a portable terminal. In the following description, a composite animation representation means an operation of simultaneously processing a key frame animation, which is represented in a fixed frame by a producer, and a physical animation that can be realistically represented according to peripheral environments.

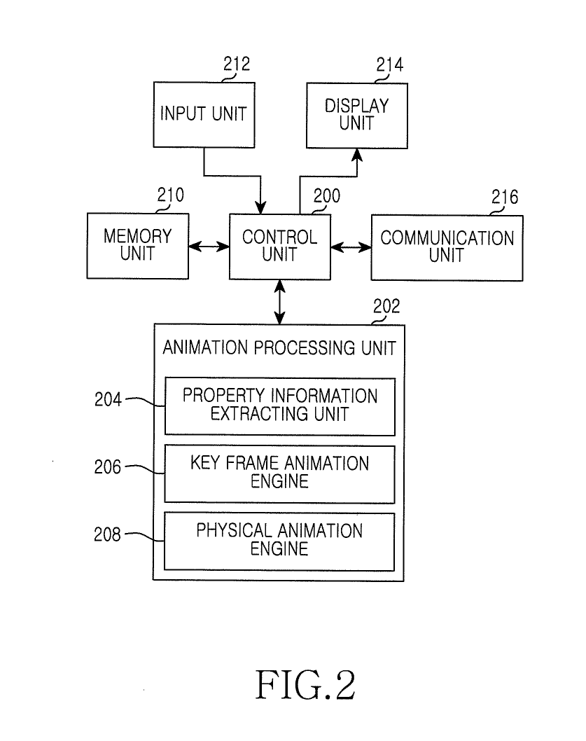

FIG. 2 illustrates a block diagram of a portable terminal for representing a composite animation according to the present invention.

As shown in FIG. 2, the portable terminal may include a control unit 200, an animation processing unit 202, a memory unit 210, an input unit 212, a display unit 214, and a communication unit 216. The animation processing unit 202 may include a property information extracting unit 204, a key frame animation engine 206, and a physical animation engine 208.

The control unit 200 controls an overall operation of the portable terminal. For example, the control unit 200 processes and controls voice communication and data communication. In addition to the general functions, according to the present invention, the control unit 100 provides a highly realistic animation effect by continuously processing a key frame animation, which is represented in a fixed frame, and a physical animation that can be realistically represented according to peripheral environments.

When processing the key frame animation scheme and the physical animation scheme continuously, the control unit 200 performs an animation smoothing operation to prevent an unnatural animation from being played at the time when the animation scheme changes.

In order to perform the animation smoothing operation, the control unit 200 extracts physical property information in the key frame animation process and uses the extracted information as an input of the physical animation engine to enable natural animation play even when the animation scheme changes.

The animation processing unit 202 performs an operation for the composite animation representation under the control of the control unit 200.

That is, the animation processing unit 202 detects a key frame animation portion and a physical animation portion, extracts animation data and applies the extracted animation data to an object to perform a key frame animation scheme.

When the key frame animation portion is ended, the animation processing unit 202 performs the physical animation scheme to provide a highly-realistic animation effect.

In order to prevent an unnatural animation from being played at the portion of changing from the key frame animation scheme to the physical animation scheme, the animation processing unit 202 extracts physical property information and uses the extracted information as an input signal of the physical animation scheme.

The key frame animation engine 206 of the animation processing unit 202 performs the key frame animation scheme, and the physical animation engine 208 performs the physical animation scheme.

After the key frame engine operates, the property information extracting unit 204 of the animation processing unit 202 performs an animation smoothing operation for natural animation play in the physical animation operation and extracts physical property information used as an input of the physical animation engine 208.

The memory unit 210 preferably includes, for example, a ROM, a RAM a flash ROM, and the like. The ROM stores a variety of reference data and microcodes of a program for the process and control of the control unit 200 and the animation processing unit 202.

The RAM is a working memory of the control unit 200, which stores temporary data that are generated during the execution of various programs. The flash ROM stores a variety of updatable data such as a phone book, an outgoing message, an incoming message, and the like.

The input unit 212 includes numeric keys of digits 0-9 and a plurality of function keys, such as a Menu key, a Cancel key, a Confirmation key, a Talk key, an End key, an Internet connection key, Navigation keys, character input keys, and the like. The input unit 212 provides the control unit 200 with key input data that corresponds to a key pressed by a user.

The display unit 214 displays numerals and characters, moving pictures, still pictures and status information generated during an operation of the portable terminal. According to the present invention, the display unit 214 displays an animation that plays a key frame animation and a physical animation in a mixed manner. The display unit 214 may be a color liquid crystal display (LCD), Active Mode Organic Light Emitting Diode (AMOLED), and the like. If the display unit 214 has a touch input device and is applied to a touch input type portable terminal, it can be used as an input device.

The communication unit 216 transmits and receives Radio Frequency (RF) signals inputted and outputted through an antenna (not illustrated). For example, in a transmitting (TX) mode, the communication unit 216 channel-encodes, spreads and RF-processes TX data prior to transmission. In a receiving (RX) mode, the communication unit 216 converts a received RF signal into a baseband signal and despreads and channel-decodes the baseband signal to restore the original data.

The control unit 200 of the portable terminal may also be configured to perform the functions of the animation processing unit 202. Although separate units are provided for respective functions of the control unit 200, the control unit 200 may also be configured to perform all or some of the functions on behalf of such separate units.

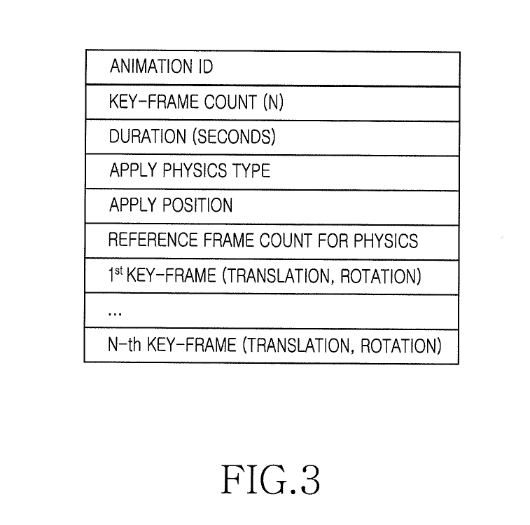

FIG. 3 illustrates a diagram of the format of a composite animation used in a portable terminal according to the present invention.

As shown in FIG. 3, the animation means a composite animation for simultaneously processing a key frame animation, which is represented in a fixed frame by a producer, and a physical animation that can be realistically represented according to peripheral environments.

Thus, in order to process a composite animation according to the present invention, the portable terminal needs an animation format that continuously represents the key frame animation and the physical animation.

As illustrated in FIG. 3, the composite animation format according to the present invention may be constructed by extending a conventional key frame animation format.

The portable terminal continuously performs the physical animation scheme after performing the key frame animation scheme. However, an unnatural animation may be played when the two animation schemes are continuously performed. Thus, the portable terminal extracts physical property information in the key frame animation process and uses the extracted information in the physical animation scheme.

The composite animation format according to the present invention includes fields containing information about physical properties to be extracted in the key frame animation scheme. For example, the composite animation format includes an Apply Physics Type field representing a physical type to be applied, an Apply Position field representing a position to apply physical properties, and a Reference Frame Count for Physics field representing a reference frame for physical property extraction.

Herein, the Apply Physics Type field contains information about a physical model type (e.g., force, rotation and impact) to be applied to an object. The Apply Position field contains information about the position in a model to apply a physical force. The Reference Frame Count for Physics field contains information about the number of reference frames for physical property extraction.

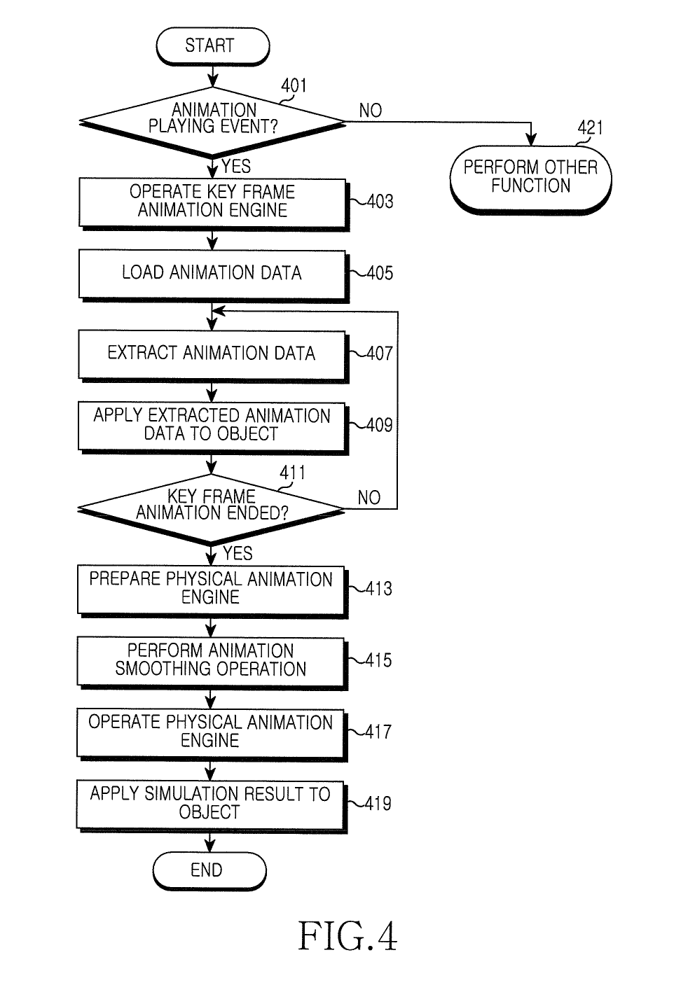

FIG. 4 illustrates a flow diagram of a process for representing an animation in a portable terminal according to an embodiment of the present invention.

As shown in FIG. 4, the portable terminal provides a highly realistic animation effect by performing a composite animation scheme that continuously processes a key frame animation, which is represented in a fixed frame by a producer, and a physical animation that can be realistically represented according to peripheral environments. That is, the portable terminal increases the realism of an animation through a composite animation obtained by applying a physical animation to a fixed animation such as an opening animation.

In step 401, the portable terminal determines whether an animation playing event occurs.

If an animation playing event does not occur (in step 401), the portable terminal proceeds to step 421 to perform other function (e.g., a standby mode).

Alternatively, if an animation playing event occurs (in step 401), the portable terminal proceeds to step 403. In step 403, the portable terminal operates a key frame animation engine to process a key frame animation. Herein, the portable terminal processes the key frame animation and then processes the physical animation.

In step 405, the portable terminal loads animation data. In step 407, the portable terminal extracts animation data.

Herein, the animation data defines composite animation properties about an object in order to continuously represent a key frame animation and a physical animation. The animation data extracted in step 407 is data of an animation to be applied to an object, and includes a moving speed and a rotating range.

That is, the portable terminal uses the animation data to determine a key frame animation portion and a physical animation portion, and processes an animation by a representation scheme corresponding to the determined portion.

In step 409, the portable terminal applies the extracted animation data to the object to play an animation.

In step 411, the portable terminal determines whether the key frame animation portion is ended.

If the key frame animation portion is not ended (in step 411), the portable terminal returns to step 407 to again perform an animation playing operation through a key frame animation.

Alternatively, if the key frame animation portion is ended (in step 411), the portable terminal proceeds to step 413. In step 413, the portable terminal prepares a physical animation engine to process the physical animation. In step 415, the portable terminal performs an animation smoothing operation.

An unnatural animation may be played when the physical animation engine is operated immediately after the key frame animation engine is operated. In order to prevent this, the portable terminal extracts physical property information in the key frame animation representation process and uses the extracted information as an input of the physical animation engine. Accordingly, the portable terminal waits for an operation of the physical animation engine until physical property information is extracted through the animation smoothing operation. Herein, the physical property information includes the traveling direction of the object, the force applied to the object, and the rotation of the object.

In step 417, the portable terminal operates the physical animation engine. In step 419, the portable terminal applies the simulation result of the physical animation engine to the object.

Through the above operations, the portable terminal increases the realism of an animation by continuously processing a key frame animation, which is represented in a fixed frame, and a physical animation that can be realistically represented according to peripheral environments.

Thereafter, the portable terminal ends the process according to the present invention.

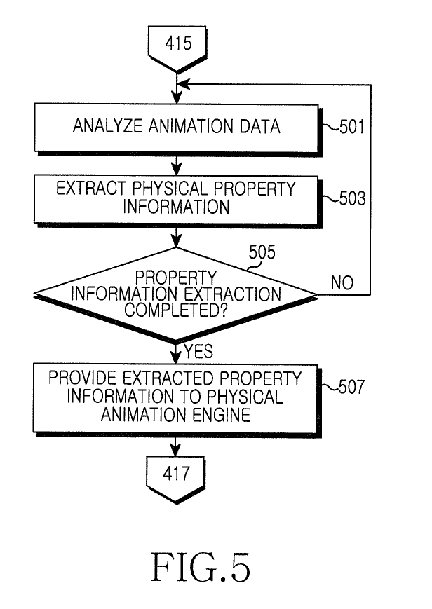

FIG. 5 illustrates a flow diagram of an animation smoothing process for extracting physical properties from a key frame animation in a portable terminal according to an embodiment of the present invention.

As shown in FIG. 5, the portable terminal perform the animation smoothing operation to extract the physical property information to be used as an input of a physical animation, when a key frame animation portion is ended.

In step 501, the portable terminal analyzes the animation data. In step 503, the portable terminal extracts physical property information.

Herein, the portable terminal may compare property information for each frame to extract the physical property information.

For example, when extracting property information corresponding to a motion vector, the portable terminal compares object motion information included in the n^{th} frame and object motion information included in the (n−1)^{th} frame, to extract a motion vector to be used as an input of the physical animation engine, which may be expressed as Equation (1).

PᵥTₙ−Tₙ₋₁ [1]

where Pᵥ denotes physical property information representing a motion vector to be used as an input of the physical animation engine, and Tₙ denotes object motion information included in the n^{th} frame.

The portable terminal may extract a motion vector through Equation (1). When the object motion information is used to extract a motion scalar, it may be obtained by using absolute values in Equation (1).

Also, the portable terminal may extract property information corresponding to a rotation angle vector through the above method, which may be expressed as Equation (2).

Aᵥ=Rₙ−Rₙ₋₁ [2]

where Aᵥ denotes a rotation angle vector to be used as an input of the physical animation engine, and Aₙ denotes object rotation information included in the n^{th} frame.

The portable terminal may extract a rotation angle vector through Equation (2). When the object rotation information is used to extract a rotation angle scalar, it may be obtained by using absolute values in Equation (2).

In step 505, the portable terminal determines whether the physical property information extraction is completed.

If the physical property information extraction is not completed (in step 505), the portable terminal returns to step 501.

Alternatively, if the physical property information extraction is completed (in step 505), the portable terminal proceeds to step 507. In step 507, the portable terminal provides the extracted physical property information to the input of the physical animation engine. Thereafter, the portable terminal proceeds to step 417 of FIG. 4 to operate the physical animation engine.

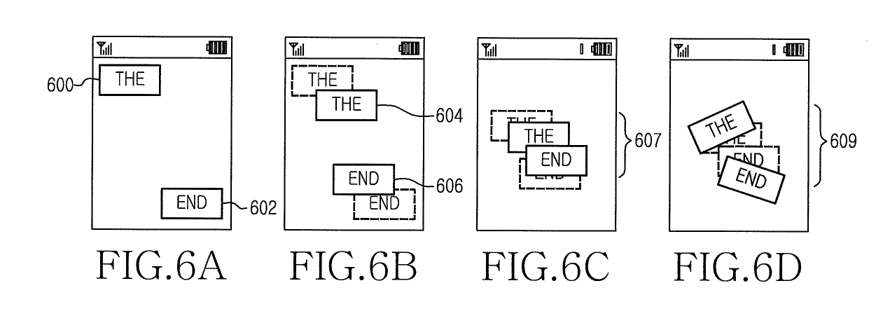

FIGS. 6A through 6D illustrate a diagram of a process for representing a composite animation in a portable terminal according to an embodiment of the present invention.

FIG. 6A illustrates a diagram an early-stage process for representing an animation by a key frame scheme in a portable terminal according to an embodiment of the present invention.

As shown in FIG. 6A, when playing a composite animation, the portable terminal plays an animation by a key frame animation scheme at the early stage.

That is, when playing a closing animation “THE END” according to the present invention, the portable terminal represents a predetermined portion in a fixed pattern by the key frame animation scheme, and continuously represents the other portion in a physical animation that can be realistically represented according to peripheral environments.

Accordingly, the portable terminal displays a “THE” frame 600 and an “END” frame 602 to represent the two frames in a fixed pattern (e.g., such that the two frames meet with each other in a predetermined mode).

FIG. 6B illustrates a diagram a middle-stage process for representing an animation by a key frame scheme in a portable terminal according to an embodiment of the present invention.

As shown in FIG. 6B, the portable terminal plays the two frames 600 and 602 in a fixed pattern to play an animation by the key frame animation scheme.

That is, the portable terminal moves the two frames 600 and 602 in a fixed pattern (604 and 606) such that the two frames 600 and 602 meet with each other.

Herein, an animation is played by the key frame animation scheme up to the portion whether the two frames meet with each other. In the key frame animation scheme, the portable terminal extracts physical property information to be used as an input of the physical animation engine, before using the physical animation scheme.

FIG. 6C illustrates a diagram a process for representing an animation by a physical animation scheme in a portable terminal according to an embodiment of the present invention.

As shown in FIG. 6C, when the key frame animation scheme is ended, the portable terminal uses the physical property information of FIG. 6B to play the animation by the physical animation scheme.

Through the above method, the portable terminal prevents an unnatural animation from being played because an animation is played by the physical animation scheme immediately after an animation is played by the key frame animation scheme.

As illustrated in FIG. 6C, the portable terminal uses the extracted physical property information to play the two frames by the physical animation scheme. Accordingly, if the two frames collide with each other (607), the portable terminal applies the properties of an object in the physical animation scheme to increase the realism of an animation, as compared to the key frame animation scheme.

FIG. 6D illustrates a diagram an animation playing screen according to a physical animation scheme in a portable terminal according to an embodiment of the present invention.

As shown in FIG. 6D, the portable terminal continuously uses the key frame animation scheme and the physical animation scheme to enable more realistic animation play than the conventional key frame animation scheme.

That is, unlike the key frame animation scheme where two frames meet with each other, the portable terminal plays an animation by applying the effect (609) that two frames collide with each other and bounce away from each other according to the properties of an object.

As described above, the present invention provides a highly realistic animation in a portable terminal. The present invention performs a key frame animation scheme and a physical animation scheme in a mixed manner. Accordingly, as compared to independently performing a key frame animation, which is represented in a fixed frame, and a physical animation, which can be realistically represented according to peripheral environments, in a conventional portable terminal, the present invention increases the realism, thus satisfying users' demands.

While the invention has been shown and described with reference to certain preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. An apparatus for providing an animation effect in a portable terminal, comprising:
an animation processing unit configured to increase the realism of an animation by performing a composite animation scheme that continuously processes a key frame animation that is represented in a fixed pattern, and a physical animation that is realistically represented according to peripheral environments; and
a display unit configured to display an animation played by the animation processing unit.

2. The apparatus of claim 1, wherein the animation processing unit comprises:
a key frame animation engine configured to perform a key frame animation scheme; and
a physical animation engine configured to perform a physical animation scheme when a portion of the key frame animation scheme is ended.

3. The apparatus of claim 1, wherein the animation processing unit extracts physical property information in the key frame animation scheme and uses the extracted physical property information as an input of the physical animation scheme.

4. The apparatus of claim 3, wherein the physical property information comprises at least one of: a traveling direction of an object, a force applied to the object, and a rotation of the object.

5. The apparatus of claim 3, wherein the animation processing unit extracts physical property information in the key frame animation scheme and uses the extracted physical property information as an input of the physical animation scheme to prevent an unnatural animation effect from being generated when changing from the key frame animation scheme to the physical animation scheme.

6. The apparatus of claim 1, wherein a format of the composite animation comprises information for physical property extraction.

7. The apparatus of claim 6, wherein the information for physical property extraction comprises at least one of: an Apply Physics Type field representing a physical type to be applied, an Apply Position field representing a position to apply physical properties, and a Reference Frame Count for Physics field representing a reference frame for physical property extraction.

8. The apparatus of claim 3, wherein the animation processing unit extracts the physical property corresponding to a traveling direction of an object by using the following equation:
Pᵥ=Tₙ₋₁Tₙ₋₁
where Pᵥ denotes physical property information representing a motion vector to be used as an input of the physical animation engine, and Tₙ denotes object motion information included in the n^{th} frame.

9. The apparatus of claim 3, wherein the animation processing unit extract the physical property corresponding to a rotation of an object by using the following equation:
Aᵥ=Rₙ−Rₙ₋₁
where Aᵥ denotes a rotation angle vector to be used as an input of the physical animation engine, and Aₙ denotes object rotation information included in the n^{th} frame.

10. A method for providing an animation effect in a portable terminal, comprising:
increasing the realism of an animation by performing a composite animation scheme that continuously processes a key frame animation that is represented in a fixed pattern, and a physical animation that is realistically represented according to peripheral environments; and
displaying an animation played by the animation processing unit.

11. The method of claim 10, wherein increasing the realism of an animation by performing the composite animation scheme comprises:
operating a key frame animation engine; and
operating a physical animation engine when a portion of a key frame animation is ended.

12. The method of claim 10, wherein increasing the realism of an animation by performing the composite animation scheme further comprises:
extracting physical property information in the key frame animation scheme before operating the physical animation engine and using the extracted physical property information as an input of the physical animation scheme.

13. The method of claim 12, wherein the physical property information comprises at least one of: a traveling direction of an object, a force applied to the object, and a rotation of the object.

14. The method of claim 12, wherein extracting the physical property information in the key frame animation scheme and using the extracted physical property information as an input of the physical animation scheme prevents an unnatural animation effect from being generated when changing from the key frame animation scheme to the physical animation scheme.

15. The method of claim 10, wherein a format of the composite animation comprises information for physical property extraction.

16. The method of claim 15, wherein the information for physical property extraction comprises at least one of: an Apply Physics Type field representing a physical type to be applied, an Apply Position field representing a position to apply physical properties, and a Reference Frame Count for Physics field representing a reference frame for physical property extraction.

17. The method of claim 13, wherein the physical property corresponding to a traveling direction of an object is extracted by using the following equation:
Pᵥ=Tₙ−Tₙ₋₁
where Pᵥ denotes physical property information representing a motion vector to be used as an input of the physical animation engine, and Tₙ denotes object motion information included in the n^{th} frame.

18. The method of claim 13, wherein the physical property corresponding to a rotation of an object is extracted by using the following equation:
Aᵥ=Rₙ−Rₙ₋₁
where Aᵥ denotes a rotation angle vector to be used as an input of the physical animation engine, and Aₙ denotes object rotation information included in the n^{th} frame.

19. An animation processing device for providing an animation effect, comprising:
a key frame animation engine configured to perform a key frame animation scheme;
a physical animation engine configured to perform a physical animation scheme when a portion of the key frame animation scheme is ended; and
a property information extracting unit configured to extract physical property information in the key frame animation scheme to be used as an input of the physical animation scheme.

20. The animation processing device of claim 19, wherein the physical property information comprises at least one of: a traveling direction of an object, a force applied to the object, and a rotation of the object.
